(19) United States
(12) Patent Application Publication
(10) Pub. No.: US 2014/0100030 A1
(43) Pub. Date: Apr. 10, 2014

(54) ADAPTING GAMING CONTENT TO A GAMING ENVIRONMENT

(71) Applicant: WMS GAMING, INC., Waukegan, IL (US)

(72) Inventors: Mary M. Burke, Somonauk, IL (US); Valentin M. Hossu, Winfield, IL (US); Craig J. Sylla, Round Lake, IL (US)

(73) Assignee: WMS GAMING, INC., Waukegan, IL (US)

(21) Appl. No.: 13/788,111

(22) Filed: Mar. 7, 2013

Related U.S. Application Data
(60) Provisional application No. 61/711,591, filed on Oct. 9, 2012.

(51) Int. Cl. G07F 17/32

(52) U.S. Cl. CPC G07F 17/3211
USPC 463/31; 463/30; 463/35

(57) ABSTRACT

A wagering game system and its operations are described herein. In some embodiments, the operations can include detecting environmental input from an environment surrounding a wagering game machine. In some embodiments, the operations further include analyzing the environmental input and determining a characteristic of the environment based on the analyzing of the environmental input. Further, in some embodiments, the operations further include adapting presentation of content via an output device associated with the wagering game machine based on the characteristic that was detected about the environment.

### LIMITED COPYRIGHT WAIVER

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### TECHNICAL FIELD

Embodiments of the inventive subject matter relate generally to wagering game systems and networks that, more particularly, adapt gaming content to gaming environments.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

Some wagering game providers have attempted to enhance the wagering game experience by implementing sound and light shows within a casino. Environmental sound and light effects within a casino can immerse a wagering game player (“player”) in the gaming experience, stimulating the player's senses. Thus, the casino's stimulating environment can greatly enhance the player's experience within the casino, which can lead to more spending on gaming and produce greater customer loyalty for the wagering game and for the casino. Thus, wagering game providers and casino operators are both interested in new and interesting concepts involving environmental immersion of the player in the gaming experience within a casino.

### BRIEF DESCRIPTION OF THE DRAWING(S)

Embodiments are illustrated in the Figures of the accompanying drawings in which:

FIG. 1 is an illustration of adapting gaming content based on environmental input, according to some embodiments;

FIG. 2 is a flow diagram 200 illustrating adapting gaming content based on environmental input, according to some embodiments;

FIG. 3 is an illustration of adapting gaming content to environmental input, according to some embodiments;

FIG. 4 is an illustration of coordinating presentation of gaming content based on environmental input, according to some embodiments;

FIG. 5 is an illustration of a wagering game system architecture 500, according to some embodiments;

FIG. 6 is an illustration of a wagering game machine architecture 600, according to some embodiments; and

FIG. 7 is an illustration of a wagering game system 700, according to some embodiments.

### DESCRIPTION OF ILLUSTRATIVE EMBODIMENTS

This description of the embodiments is divided into five sections. The first section provides an introduction to embodiments. The second section describes example operations performed by some embodiments while the third section describes additional example embodiments. The fourth section describes example operating environments while the fifth section presents some general comments.

### Introduction

This section provides an introduction to some embodiments.

As specified previously, there is a strong interest in gaming innovations that incorporate wagering games and gaming environments. Some embodiments of the inventive subject matter are directed to detecting environmental inputs of an environment associated with a wagering game machine (also referred to as an electronic gaming machine (EGM)). The environmental inputs are related to characteristics of an environment that surrounds the wagering game machine, such as lights, sounds, colors, patterns, etc. of objects, devices, individuals, and so forth, within a gaming venue (e.g., within a casino). Some embodiments are further directed to adapt gaming content to the environmental input (e.g., audio content, visual content, textual content, etc.) based on the environmental input. In some embodiments, adapting gaming content can include recommending, selecting, generating, or modifying content that would cause the wagering game machine to stand out from its environment or make the wagering game machine more appealing to use. In some embodiments, adapting gaming content can include providing content that compliments or conforms to, one or more parts of the environment. In some embodiments, adapting gaming content can include providing content that contrasts, or appears non-conformal, with one or more parts of the environment. Further, in some embodiments, adapting gaming content can include coordinating content presented via the wagering game machine (and/or via output devices associated with the wagering game machine) with other content that is presented in the environment.

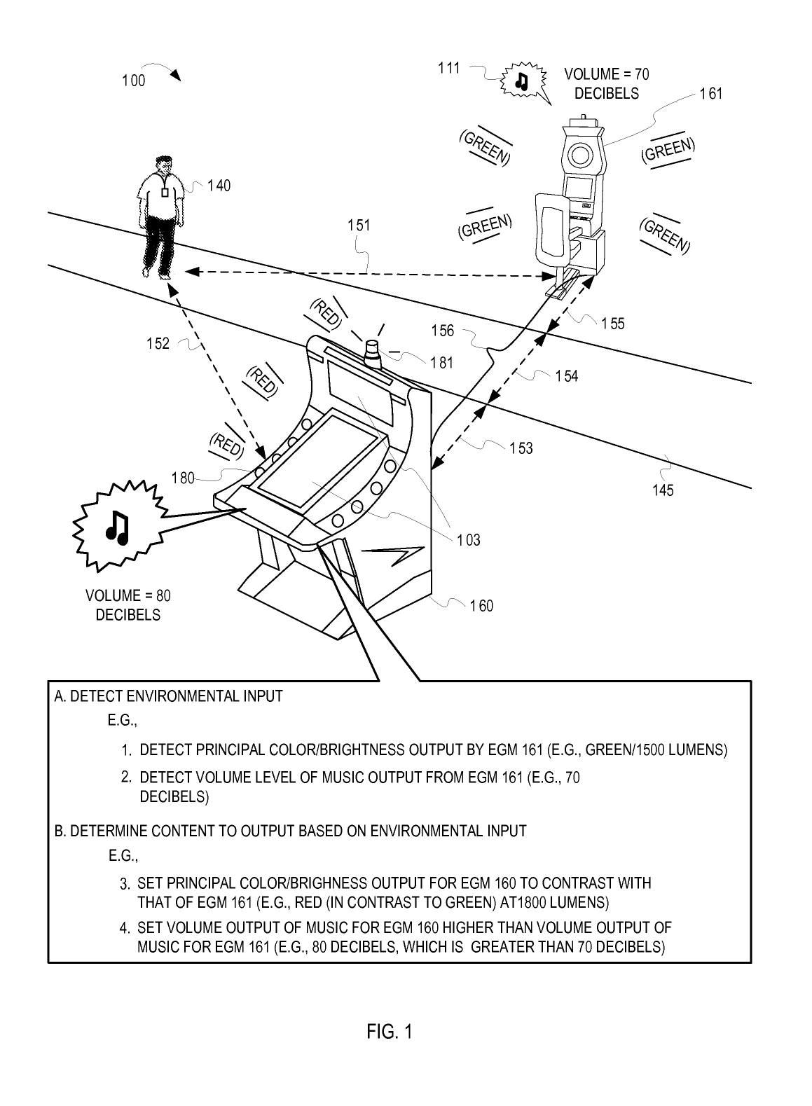

FIG. 1 is a conceptual diagram that illustrates an example of adapting gaming content based on environmental input, according to some embodiments. In FIG. 1, a wagering game system (“system”) 100 includes a wagering game machine 160. The wagering game machine 160 is within a wagering game venue, such as a casino. The wagering game machine 160 is configured to sense the environment around the wagering game machine 160 and generate output based on the environment. For example, the wagering game machine 160 may be equipped with sensing mechanisms (e.g., light meters, cameras, microphones, location detectors, pressure sensors, thermometers, etc.), which detect environmental inputs (e.g., lights, sounds, colors, movement, distances, pressures, temperatures, identifiers, etc.). The sensing mechanisms can detect the environmental inputs continuously and automatically and, based on the detection of the environmental inputs adapt gaming content.

In FIG. 1, the wagering game machine 160 will be described as detecting environmental inputs. However, in other examples, the system 100 includes sensing mechanisms that are not attached to the wagering game machine 160, but that detect environmental input of the environment around the wagering game machine 160 (e.g., sensors attached to devices, individuals, or structures within the wagering game venue, such as on wagering game machine 161 or on a patron 140). Furthermore, in FIG. 1, the wagering game machine 160 will be described as adapting content based on the environmental input. However, in other examples, the system 100 can include other devices (e.g., a wagering game server), that receives the environmental input (e.g., either collected via sensors of the wagering game machine 160 and/or collected by other sensing mechanisms in the environment) and analyzes the environmental input instead of, or in addition to, the wagering game machine 160. The other devices (e.g., the wagering game server) can further recommend specific content to the wagering game machine 160 to present and/or provides the content to the wagering game machine 160.

In some examples, the wagering game machine 160 collects environmental input about an environment depicted in FIG. 1. For example, the wagering game machine 160 detect the appearance, sound, or other characteristics of the patron 140, the wagering game machine 161, and the path 145 and adapts a presentation of content based on the environmental input. For example, the wagering game machine 160 collects the environmental input by taking and analyzing pictures (e.g., via image analysis of pictures taken from the perspective of the wagering game machine 160). In other examples, the wagering game machine 160 collects input by using wireless measurement signals (e.g., via lasers, infrared beams, etc. projected from the wagering game machine 160). In some embodiments, using the environmental input, the wagering game machine 160 calculates approximate distances between the patron 140 and the wagering game machines 160 and 161. For example, the wagering game machine calculates a distance 151 between the wagering game machine 161 and the patron 140, a distance 152 between the wagering game machine 160 and the patron 140, a distance 153 of the wagering game machine 160 from the path 145, a distance 154 of the wagering game machine 161 from the path 145, a distance 155 of the width of the path 145, and a distance 156 between the wagering game machine 160 and the wagering game machine 161. The wagering game machine 160 continuously tracks the changes to the distances 151 and 152 as the patron 140 moves relative to (e.g., toward or away from) the wagering game machines 160 and 161. In some embodiments, the wagering game machine 160 collects environmental input about the details (e.g., sound levels, colors, etc.) for the attract mode of the wagering game machine 161 by recording sounds (e.g., via microphones associated with the wagering game machine 160) and detecting appearances (e.g., via cameras, light sensors, etc. associated with the wagering game machine 160). For example, the wagering game machine 160 detects that the wagering game machine 161 presents visual content for an attract mode that is primarily green in color with a brightness measured at approximately one-thousand five hundred (1500) lumens. The wagering game machine 160 also detects that the wagering game machine 161 presents sounds 111 at a sound volume level of approximately seventy (70) decibels.

In one example, the wagering game machines 160 adapts parameters for its attract mode attract mode based on the environmental input related to the patron 140 and the wagering game machine 161. For example, the wagering game machine 160 can detect a location of the patron 140 as the patron 140 walks on a path 145 toward the wagering game machines 160 and 161. Each of the wagering game machines 160 and 161 has an attract mode to attract patrons who pass by, such as patron 140. The wagering game machine 160 senses environmental input about the wagering game machine 161, including details (e.g., sound levels, colors, etc.) about the attract mode of the wagering game machine 161. Consequently, based on the relative location of the patron 140 to the wagering game machines 160 and 161, and based on the details about the attract mode of the wagering game machine 161, the wagering game machine 160 presents content during its attract mode that contrasts with, or exceeds sound and light levels of, the attract mode of the wagering game machine 161. The wagering game machine 160, thus, presents an attract mode that will stand apart from the attract mode produced by the wagering game machine 161. The wagering game machine 160 can, thus, more likely attract the attention of the patron 140.

For instance, based on the calculated distances 151-156, and based on the details of the attract mode for the wagering game machine 161, the wagering game machine 160 computes parameters for light and sound content to present for its own attract mode to contrast with, and exceed sound and light levels of, the attract mode for the wagering game machine 161. In one example, the wagering game machine 160 sets a primary color for the visual content of its attract mode to the color red, to contrast with the color green of the visual content of the attract mode for the wagering game machine 161. In another example, the wagering game machine 160 presents red lighting from via emotive light elements 180, red lighting from a candle 181, or content from displays 103 that is primarily red in color. The wagering game machine 160 can further set a sound volume of its audible content to a volume level (e.g., eighty (80) decibels) that will sound louder, at the location of the patron 140 on the path 145, than will the volume (e.g., 70 decibels) of audible content presented by the wagering game machine 161. The wagering game machine 160 can further set a light intensity of its visible content to be a brightness of approximately one-thousand eight hundred (1800) lumens, which is higher than the 1500 lumen light intensity of content presented by the wagering game machine 161.

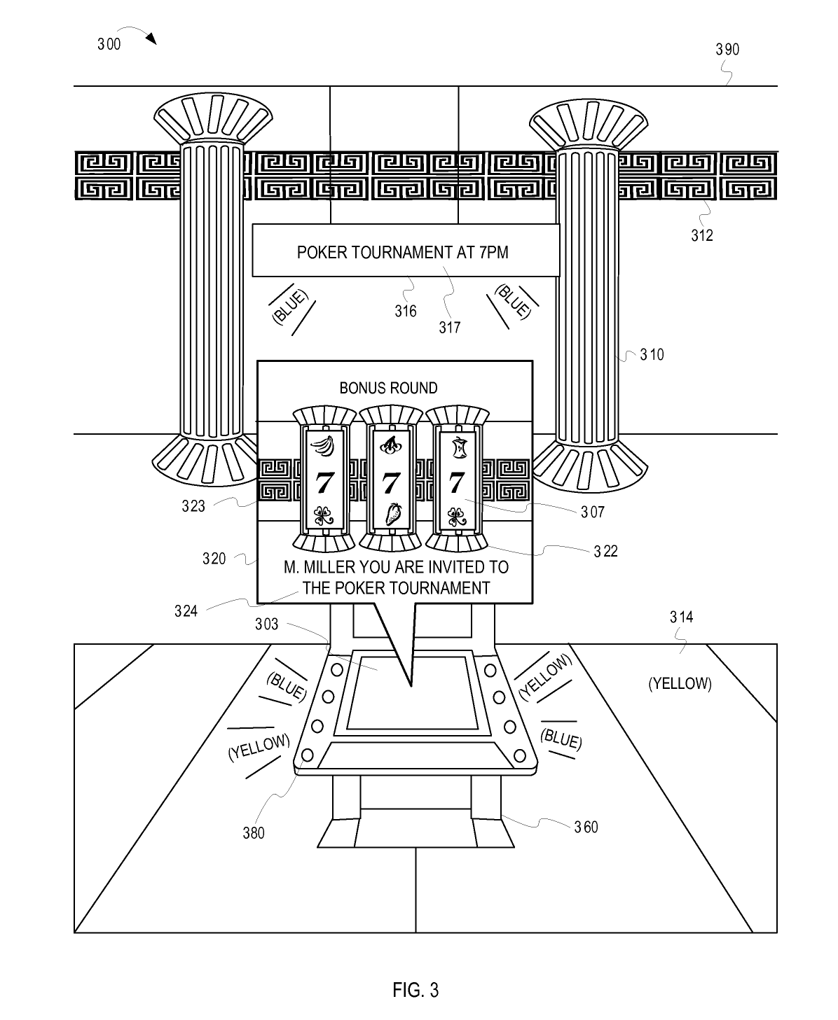

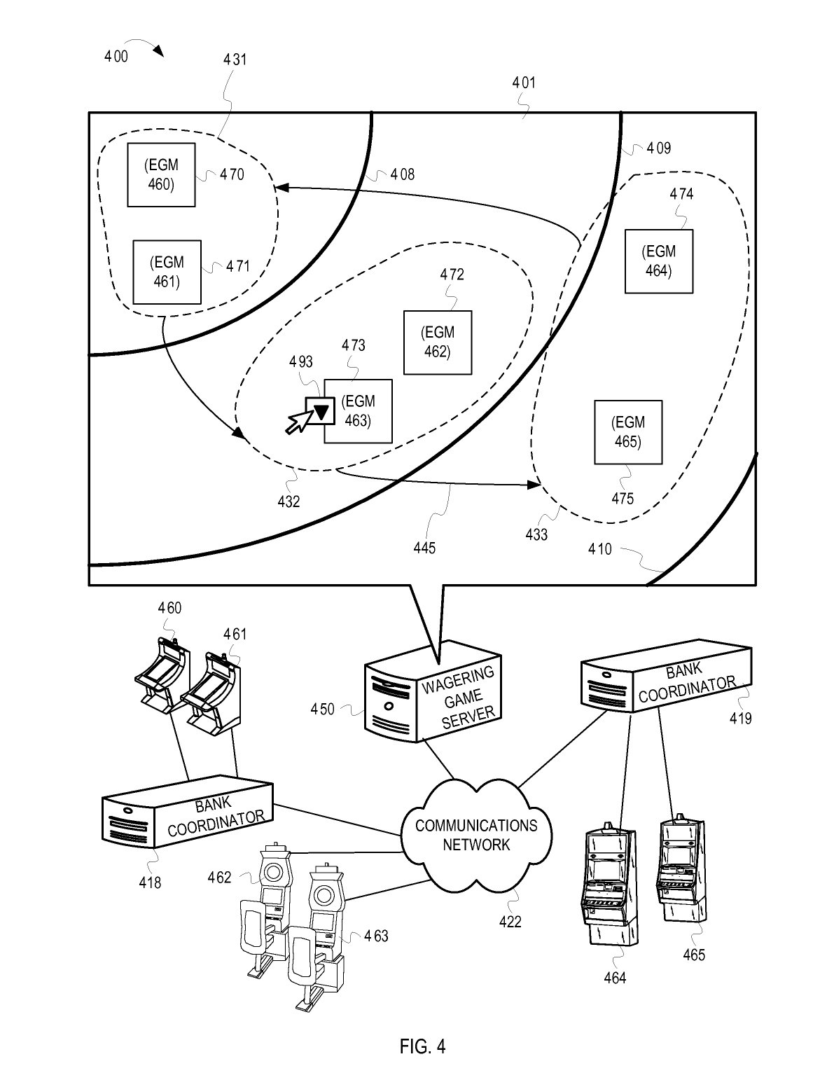

Although FIG. 1 includes an example where the system 100 sets audible and visual parameters of an attract mode for the wagering game machine 160 based on environmental input, other embodiments can set parameters for a variety of different types content based on a variety of different types of environmental data. For example, in some embodiments, the system 100 can modify wagering game content (e.g., primary games, secondary games, bonus games, group games, persistent wagering games, progressives, tournaments, etc.), content related to marketing and advertising, content related to social communications, content related to casino services, etc. instead of, or in addition to, modifying content for an attract mode. Furthermore, the system 100 can adapt content of any number of other devices within the gaming venue based on the environmental input instead of, or in addition, to adapting content for the wagering game machine 160. For example, the system 100 can modify content presented via the wagering game machine 161, content presented via overhead lighting, content presented via group game devices, content presented via advertising displays, content presented via kiosks, content presented via docking stations, content presented via personal mobile devices, etc. Furthermore, the system 100 can adapt content to compliment, conform with, or coordinate with other content or with the appearance of an environment, instead of, or in addition to, contrasting with content (e.g., see FIGS. 3 and 4). In some embodiments, the system 100 can also detect preferences for a player (e.g., of the patron 140) and, based on the environmental input and the player preference, adapt content accordingly.

Furthermore, although FIG. 1 illustrates an example of adapting content based on environmental input of a wagering game machine within a casino, some embodiments can adapt gaming content to a gaming environment in a network wagering venue (e.g., an online casino, a wagering game website, a wagering network, etc.) using a communication network. Embodiments can be presented over any type of communications network that provides access to wagering games, such as a public network (e.g., a public wide-area-network, such as the Internet), a private network (e.g., a private local-area-network gaming network), a file sharing network, a social network, etc., or any combination of networks. Multiple users can be connected to the networks via computing devices. The multiple users can have accounts that subscribe to specific services, such as account-based wagering systems (e.g., account-based wagering game websites, account-based casino networks, etc.).

Further, for purposes of the present detailed description, a user may be referred to as a player (i.e., of wagering games), and a player may be referred to interchangeably as a player account. Account-based wagering systems utilize player accounts when transacting and performing activities, at the computer level, that are initiated by players. Therefore, a “player account” represents the player at a computerized level. The player account can perform actions via computerized instructions. For example, in some embodiments, a player account may be referred to as performing an action, controlling an item, communicating information, etc. Although a player, or person, may be activating a game control or device to perform the action, control the item, communicate the information, etc., the player account, at the computer level, can be associated with the player, and therefore any actions associated with the player can also be associated with the player account. Therefore, for brevity, to avoid having to describe the interconnection between player and player account in every instance, a “player account” may be referred to herein in either context. Further, in some embodiments herein, the word “gaming” is used interchangeably with “gambling.”

Furthermore, for purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

Although FIG. 1 describes some embodiments, the following sections describe many other features and embodiments.

### EXAMPLE OPERATIONS

This section describes operations associated with some embodiments. In the discussion below, some flow diagrams are described with reference to block diagrams presented herein. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform more or less than all the operations shown in any flow diagram.

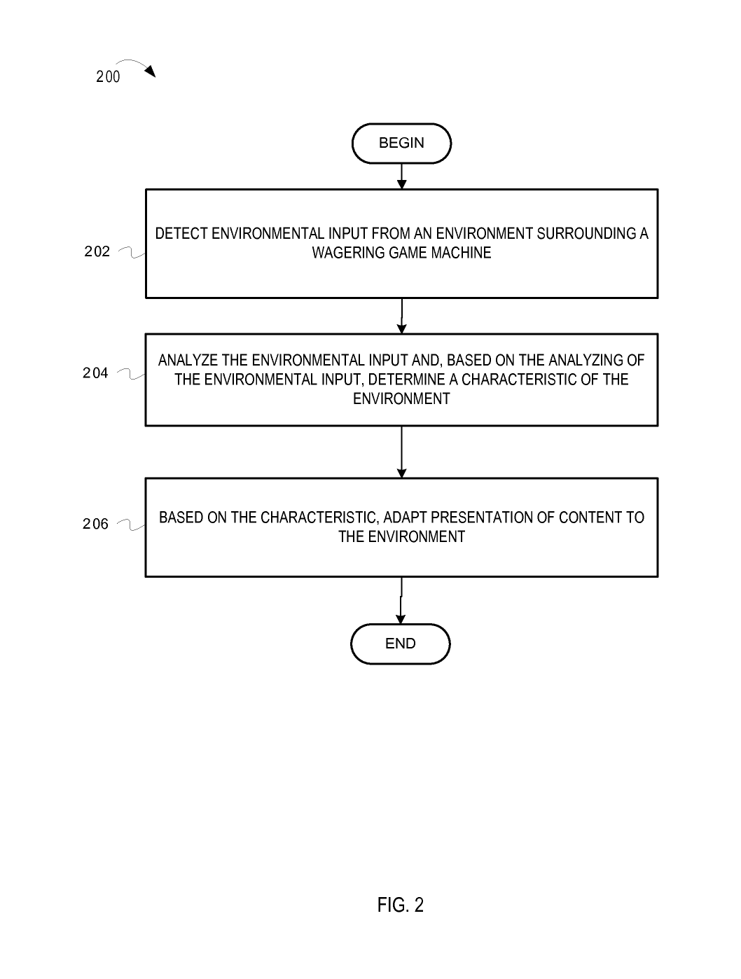

FIG. 2 is a flow diagram (“flow”) 200 illustrating adapting gaming content based on environmental input, according to some embodiments. In FIG. 2, the flow 200 begins at processing block 202, where a wagering game system (“system”) detects environmental input from an environment surrounding a wagering game machine. FIG. 1 above illustrated examples of detecting environmental input, such as detecting the appearance, actions, sounds, etc. of the wagering game machine 161, the patron 140, and other objects, such as the location of patron 140 relative to the wagering game machine 160 and the path 145. The system 100 includes sensing mechanisms, such as sensors (e.g., heat sensors, motion detectors, light detectors, sound detectors, pressure sensors, distance or proximity detectors, etc.), cameras (e.g., still shot cameras, video cameras, infrared cameras, etc.), or any other instrument or device used to capture, record, or otherwise determine information about the environment. The devices used to determine information about the environment can be included in the wagering game machine 160, in other devices within a gaming venue, or both. In other examples, a wagering game machine, or bank of wagering game machines, broadcast their presence (e.g., broadcast identification information and other information about their environments). In some embodiments, each wagering game machine may have a unique address on a network (e.g., a universal resource locator, or URL, an internet protocol address, etc.). After broadcasting information, other devices that receive the information can store the information for later analysis, interpretation, and use. In some embodiments, devices within the environment, such as wagering game machines, are configured to emit a light or sound pattern (e.g., a color pattern, a tone pattern, etc.) that other wagering game machines can detect and identify based on the light or sound pattern. In some embodiments, the system can detect and track a change to the environmental inputs, such as detecting ambient brightness over time, a degree of usage of devices, etc.

The flow 200 continues at processing block 204, where the system analyzes the environmental input, and, based on the analyzing of the environmental input, determines a characteristic of the environment. For example, the system can include a camera that takes pictures of visible characteristics of objects within an environment (e.g., wagering game machines, patrons, furnishings, lighting devices, room dimensions, etc.). The system then analyzes the appearance of the visible characteristics of the objects within the pictures, including analyzing appearance of perspective, depth, shadowing, size, contrast, brightness, color, etc. of the objects, in comparison to other objects within the pictures and/or of known characteristics. In other examples, the system collects input by using wireless measurement signals (e.g., via lasers, infrared beams, etc.). For example, in some embodiments, the system utilizes a laser distance detector to detect distances of objects. In some embodiments, the system detects distances utilizing radio frequency identifiers (RFID), global positioning systems (GPS), etc. In some embodiments, the system utilizes light intensity sensors to detect light intensity and microphones to detect sound volume. In some embodiments, the system records sounds and analyzes sound characteristics, such as sound patterns, timing, chord patterns, melodies, etc. The system further compares the sound characteristics to known sound content.

Based on the analyzing of the environmental input, the system detects various types of characteristics, such as light patterns, light brightness levels, colors, sound patterns, sound volume levels, sound pitch, location of devices, identity of devices, orientation of devices, location of patrons, movement of patrons, density of patrons, identity of patrons, distances between objects, size of objects, movement of objects, etc.

The flow 200 continues at processing block 206, where the system, based on the characteristic, adapts presentation of content to the environment. The system presents the adapted content via an output device associated with the wagering game machine. For instance, as described in FIG. 1, the system 100 determined attract mode content to present based on characteristics of environmental input of the environment around the wagering game machine 160. In some embodiments, the system alters content that is already presented via a wagering game machine, such as altering one or more of color content, sound content, attract content, a game theme, and functionality of a wagering game based on the characteristic. For instance, in some embodiments, the system changes game type, color type, theme type, etc. (e.g., the system selects a different color module or shader module to apply within an existing wagering game application). In some embodiments, the system modifies a visible characteristic of a wagering game machine's casing or cabinet. In some examples, the system detects environmental sounds to modify a volume level for content presented at a wagering game machine (e.g., to increase volume to overcome ambient noises or to lower volume because ambient noise is too loud). In some embodiments, the system detects a common key of sounds presented within the environment and adapts sound content presented to have a different key. In some embodiments, the system varies sound levels, pitches, or other characteristics. In some embodiments, the system presents stereoscopic sound based on a location of individuals in the environment.

In some embodiments, the system detects a change to environmental input over time. For example, the system detects, via sensors, a change in the ambient brightness of the environment and, in response, changes a brightness of content output to compensate for the change in the ambient brightness.

In some examples, a system compares the characteristic of the environment to descriptions of content stored within a data store of content. In some embodiments, the data store includes data records (e.g., database records) with one or more fields that describe a type of the content, such as color type, a sound type, etc. In some embodiments, the system detects default setting for content, such as default volume levels, default colors, default intensity, default duration, etc. Based on the descriptions of content stored within the data store, the system selects content from the data store that is similar to the characteristic, different from the characteristic, or in some other way related to the characteristic. For instance, if, as in FIG. 1, the system 100 detected that the wagering game machine 161 presented a content color that was primarily green. In some embodiments, the system 100 references an organized listing of colors that describes a degree of contrasting or complimentary appearance relative to each other (e.g., a color wheel). In some embodiments, the system 100 can refer to a variety of color wheels that are tailored to specific conditions or different environments (e.g., a first color wheel is tailored for use with an attract mode whereas a second color wheel is tailored for use with a congratulatory gaming effect or a first color wheel is tailored for use in a first section of a casino floor whereas a second color wheel is tailored for use in a second section of the casino floor). Based on the reference to the color wheel, the system 100 determines that green is a highly contrasting color with red and yellow, and moderately contrasting with purple and orange. The system further detects an identity of the patron 140 and looks up, in a player account, a listing of preferences for the player. Within the preferences, the system 100 determines that the patron 145 prefers bright colors, or, more specifically, prefers bright colors with a reddish hue (e.g., bright red, bright orange, and light purple) to other bright colors such as yellow, light blue, or light green. Further, the system 100 analyzes available content and determines, based on descriptive tags associated with content stored in a content data store, that, for an attract mode, content is available with primarily red colors or orange colors. The system can further detect other colors within the casino, other than the color of wagering game machine 161. If, for example, the wagering game machine 160 is near another wagering game machine (from a competing manufacturer) that presents an attract mode primarily in a bright orange, the system 100 can select, for the attract mode of wagering game machine 160, content that is primarily red, to have some contrast with the bright orange color of the neighboring wagering game machine. Furthermore, in some embodiments, the system 100 detects that an additional neighboring wagering game machine (of the same manufacturer), is currently presenting an attract mode that is primarily purple in color. The system 100, therefore, may coordinate the attract mode for the wagering game machine 160 with that of the neighboring wagering game machine of the same manufacturer to have a coordinated red and purple attract sequence, with both wagering game machines presenting the content with a light intensity higher than that of the attract modes for other nearby wagering game machines.

In some embodiments, the system refers to a rules store to determine whether specific content is appropriate to present given certain environments, conditions, situations, events, etc. For example, by referencing a rule set, the system can prevent conflicts of presentation set by a wagering game manufacturer, a casino, etc. In other embodiments, by referencing a rules set, the system can prevent a presentation of content that appears disjointed or chaotic. The system can access different rules based on different situations (e.g., rules to present content for different times of day, rules to present content for different manufacturing types, rules to present content for different gaming events, etc.).

In some embodiments, the system adapts wagering game content presented via a primary display of a wagering game machine (e.g., wagering game content for a primary or secondary wagering game presented via a display, splash screens for an attract mode, etc.). In other embodiments, however, the system adapts content that is presented apart from a primary display of the wagering game machine. For example, the system can determine content to present from secondary output devices, such as emotive lighting devices, top-box displays, peripheral displays, or other devices that do not directly present a wagering game during a wagering game session conducted via the wagering game machine.

FIG. 3 illustrates another example of adapting content based on environmental input. In FIG. 3 a wagering game system (“system”) 300 includes a wagering game machine 360 configured to adapt content based on environmental input. In some embodiments, as described previously regarding system 100 in FIG. 1, system 300 may include many other devices. The wagering game machine 360, similar to wagering game machine 160 of FIG. 1, is configured to sense environmental input, such as characteristics or features of architecture (e.g., pillars 310, dimensions of a room in a wagering game venue, etc.), furnishings (e.g., wallpaper pattern 312, color and pattern of carpet 314, furniture, etc.), devices (e.g., overhead display 316, other wagering game machines, etc.), or other objects (e.g., patrons, advertising displays, group game content, etc.). In one example, the wagering game machine 360 detects a color of an overhead display 316 (e.g., primarily the color blue) and a color of carpet 314 (e.g., primarily the color yellow). For example, the wagering game machine 360 includes a camera that faces towards the pillars 310 and which detects the appearance of objects within a casino 390, such as the overhead display 316, the pillars 310, the wallpaper pattern 312, etc. The wagering game machine 360 also includes a side-wards facing camera that detects a color of the carpet 314. Based on characteristics of the environment, such as the color of the overhead display 316 and the color of the carpet 314, the wagering game machine 360 presents, via emotive light elements 380, matching colors (e.g., yellow and blue).

In another example, the wagering game machine 360 presents wagering game content 320 (e.g., a bonus game) that includes objects that appear similar to environmental objects visible in the environment that surrounds the wagering game machine 360. For instance, within the wagering game content 320, the wagering game machine 360 presents virtual pillars 322 that appear similar in appearance to pillars 310 and a virtual pattern 323 that appears similar to a wallpaper pattern 312. The virtual pillars 322 integrate with wagering game elements, such as virtual slot reels 307 (i.e., the virtual slot reels 307 appear to scroll within the virtual pillars 322). Furthermore, in some embodiments, the wagering game machine 360 detects content 317 of the overhead display 316. The wagering game machine 360 analyzes the content and determines, from the content, that a poker tournament is going to occur at a given time and date. The wagering game machine 360 queries one or more devices within the system 300 to identify the poker tournament and determine details regarding the tournament. Based on the details about the tournament, the system 300 detects that a player associated with the wagering game machine 360 (e.g., a player who is logged in to the wagering game machine 360 via a player account), is qualified to enter the tournament. In some embodiments, the wagering game machine 360 presents, via a display 303 of the wagering game machine 360, a message 324 that indicates an invitation to the player for the poker tournament.

### ADDITIONAL EXAMPLE EMBODIMENTS

According to some embodiments, a wagering game system (“system”) can provide various example devices, operations, etc., to adapt gaming content to a gaming environment. The following non-exhaustive list enumerates some possible embodiments.

Adapt content to user characteristics and preferences. In some embodiments, the system detects environmental input visible from a user's perspective (e.g., receives environmental input and determines which of the environmental input is perceptible based on a user's orientation, location, etc.). For instance, in FIG. 3, the system 300 detects visible environmental input that is viewable behind and to the sides of the wagering game machine 360, which the user would see when seated at the wagering game machine 360. Based on the viewing perspective of the user, therefore, the system 300 adapts the content presented via the wagering game machine 360. In some embodiments, the system detects a user-preference for a characteristic of the content. For example, in some embodiments, when the system detects environmental input, the system can refer to user preferences, such as for a user seated at a wagering game machine. Based on the user preferences, the system can determine whether to select contrasting or complimenting content. For instance, if the system detects pop music being played in the environment, and if the system detects that a user prefers rock music to pop music, the system can replace a soundtrack with rock music and make the soundtrack louder than the pop music that is audible in the environment. In some embodiments, the system prioritizes content to present based on the user preferences to override a system preference, or default. For example, referring to FIG. 1, the system 100 may be programmed, by default, to present contrasting colors for its attract mode. The system 100 is further configured to detect an identity of the patron 140 (e.g., that the patron 140 has a player tracking device such as a player card with an RFID chip or a registered personal mobile device). The system 100 then accesses a profile for the patron 140, which indicates a preference for the color green. The system 100, therefore, may override the default setting to present a contrasting color to green (as presented by the wagering game machine 161) and instead present green with greater intensity, more graphical movement, or with some other characteristic that distinguishes over the attract mode of the wagering game machine 161.

Coordinate gaming content based on environmental input. In some embodiments, the system can detect environmental input from various locations within a gaming venue and, based on the those environmental inputs generate a casino map of the environment and/or coordinate content presentations of content at the various locations within the gaming venue. FIG. 4 illustrates an example. In FIG. 4, a wagering game system (“system”) 400 includes a wagering game server 450 connected to various gaming devices via a communications network 422. Some of the gaming devices within the system 400 include bank coordinators 418 and 419, configured to control bank related events at banks of wagering game machines. For example, bank coordinate 418 coordinates content presentations for wagering game machines 460 and 461. Bank coordinator 419 coordinates content presentations for wagering game machines 464 and 465. The wagering game server 450 is connected to the bank coordinators 418 and 419 via the communications network 422. The wagering game machines 460 and 461 are connected to the bank coordinator 418, but in other embodiments are also, or are instead, directly connected to the communications network 422. The wagering game machines 464 and 465 are connected to the bank coordinator 419, but, in other embodiments are also, or are instead, directly connected to the communications network 422. The wagering game server 450 is also connected to the wagering game machines 462 and 463 via the communications network 422. In some embodiments, the wagering game machines 460, 461, 462, 463, 464, and 465 are inside of one or more gaming venues, and may be at different locations within a gaming venue. The wagering game server 450 generates a casino floor map 401 that shows virtual representations (e.g., virtual objects 470, 471, 472, 473, 474, and 475) that represent, respectively, the wagering game machines 460, 461, 462, 463, 464, and 465. For example, virtual object 470 represents wagering game machine 460, virtual object 471 represents wagering game 461, and so forth. Within the casino floor map 401, the wagering game server 450 indicates distances ranges 408, 409, and 410. The distance ranges 408, 409, and 410 represent actual distances, within the gaming venue, from the wagering game machine 460. For example, because wagering game machine 461 is near the wagering game machine 460, the casino floor map 401 shows the virtual object 471 within the first distance range 408 to the virtual object 470. Wagering game machines 462 and 463 are in a wagering game bank that is further from the wagering game machine 460 than the wagering game machine 461. Therefore, the casino floor map 401 shows the virtual objects 472 and 473 (representing wagering game machines 462 and 463) as being outside of the distance range 408 and within the distance range 409. Furthermore, wagering game machines 464 and 465 are in a wagering game bank that is further from the wagering game machine 460 than the wagering game machine 461 and the bank for wagering game machines 462 and 463. Therefore, the casino floor map 401 shows the virtual objects 474 and 475 (representing wagering game machines 464 and 465) as being outside of the distance range 409 and within the distance range 410.

The wagering game server 450 receives environmental input regarding the environments around wagering game machines 460, 461, 462, 463, 464, and 465 and adapts content according to the environmental input. For example, the wagering game server 450, using the environmental input, generates a coordinated content presentation between the wagering game machines 460, 461, 462, 463, 464, and 465. For instance, the wagering game server 450 detects an increase in density of wagering game patrons near one of more of the wagering game machines 460, 461, 462, 463, 464, and 465 and, in response, generates a light presentation show to be presented on environmental lighting elements associated with the wagering game machines 460, 461, 462, 463, 464, and 465. The coordinated presentation of the light show can span across the wagering game machines 460, 461, 462, 463, 464, and 465 in a way that uses each of the wagering game machines 460, 461, 462, 463, 464, and 465 as nodes of the content presentation. In some embodiments, the wagering game server 450 can also utilize groupings 431, 432, and 433 of the wagering game machines 460, 461, 462, 463, 464, and 465 as nodes. In some embodiments, the groupings 431, 432, and 433 are based on proximity of certain ones of the wagering game machines 460, 461, 462, 463, 464, and 465 to each other (e.g., wagering game machines 460 and 461 are close to each other in a first bank, wagering game machines 462 and 463 are close to each other in a second bank and are within the distance range between 408 and 409, and wagering game machines 475 and 476 are within the distance range between 409 and 410). Each of the nodes (e.g., wagering game machines 460, 461, 462, 463, 464, and 465 and/or groupings 431, 432 or 433) can present coordinated content in various ways. For example, the wagering game server 450 can provide a light show that runs at the same time at each of the nodes (i.e., synchronized presentation by all nodes). In other embodiments, the wagering game server 450 can provide a light show that is timed to present at a first of the nodes slightly before a second of the nodes, and so forth, to generate a staggered presentation. In some embodiments, the wagering game server 450 can present a coordinated presentation at the nodes according to some characteristics (e.g., timing characteristics or pattern presentation), but with different characteristics at each of the nodes based on the environment surrounding those nodes (e.g., different color selections for each of the groupings 431, 432, and 433 based on the environment around the groupings 431, 432, and 433). For example, the wagering game server 450 may present a coordinated light show that flows between nodes according to a timing pattern 445 (e.g., the lighting show appears to flow from grouping 431 to grouping 432, then to grouping 433). Thus, the timing pattern 445 for presentation of the light show is coordinated between the nodes associated with groupings 431, 432, and 433. However, the environment around each of the groupings 431, 432, and 433 may be slightly different from each other. Within the first grouping 431, for instance, other devices may produce a primary color of green, and, therefore, to contrast with those other devices, the wagering game server 450 may adapt the coordinated light display to have primarily red colors when presented via wagering game machines 460 and 461. At the same time, some individuals may surround wagering game machines 462 and 463 (the grouping 432), which individuals may prefer colors that are different from red. For instance, the wagering game server 450 may determine (e.g., via access to player preferences stored in player accounts associated with those individuals), that the individuals prefer the colors blue and green. Therefore, the wagering game server 450, while presenting the coordinated light show according to the timing pattern 445, may change the primary colors of the light show presented via wagering game machines 462 and 463 to primarily include blue and green. At the same time, the wagering game server 450 may determine that a jackpot has recently been hit by wagering game machine 464 and, therefore, the coordinated light presentation should use colors that compliment colors of visual effects of a jackpot celebration.

In some embodiments, the wagering game server 450 generates the timing pattern 445 for presentation via the nodes by detecting a presentation pattern of content within the environment and generating the timing pattern 445 based on the presentation pattern. For example, in some embodiments, the wagering game server 450 receives environmental input regarding content presented by overhead lighting or emotive lighting fixtures within a casino. The presentation pattern, for example, may include a sequence of flashing lights that indicate that a specific event occurred recently within the casino (e.g., a jackpot win, a group game announcement, etc.). The wagering game server 450 analyzes the environmental input and generates the timing pattern 445 to match a timing of the sequence of flashing lights. Thus, the wagering game server 450 generates a coordinated content presentation that conforms to a pattern already presented within the environment. Presentation patterns can include patterns related to light, sound, graphics, or any other type of content that is presented in a way that changes with time according to a pattern or sequence.

Furthermore, the wagering game server 450 may determine priorities of environmental input and, based on the priorities, adapt the coordinated presentation of content across nodes. For example, if the wagering game machine 464 experiences a jackpot celebration, the jackpot celebration may have a very high priority compared to other events that may be detected within the environment. Therefore, the wagering game server 450 can refer to priority rules. For example, if the wagering game machine 464 experiences a jackpot celebration, based on analysis of the priority rules, when the wagering game server 450 provides instructions to the wagering game machine 464 for the coordinated presentation (e.g., for a coordinated light show), the wagering game server 450 can include instructions to present the coordinated presentation on only certain emotive lighting elements of the wagering game machine 464 (e.g., only on emotive lighting elements above the wagering game machine 464 to prevent interference with the jackpot celebration on emotive lighting elements on the sides of the wagering game machine 464). In some embodiments, the wagering game server 450 may provide instructions to skip presentation of the coordinated light show at the wagering game machine 464 while the jackpot celebration plays so as not to overwhelm or interfere with the jackpot celebration.

In some embodiments, the wagering game server 450 presents user interface controls via the casino floor map 401 for a user to manually select and set parameters for a coordinated presentations between nodes. For example, when a mouse cursor is placed over the virtual object 473, a dropdown control 493 appears. The dropdown control 493 can be selected and can present a menu of options to configure the virtual object 473, which options refer to a presentation of content via wagering game machine 463 during the coordinated content presentation. For example, the menu may include options about color, timing, sounds, themes, messages, etc. of wagering game machine 463.

Furthermore, although FIG. 4 illustrated an example of a central controller, such as the wagering game server 450, that coordinates presentation of content between wagering game machines 460, 461, 462, 463, 464, and 465, other embodiments may include distributed, or peer-to-peer coordination. For instance, in some embodiments, devices within the environment, such as wagering game machines 460, 461, 462, 463, 464, and 465, are configured to emit a light or sound pattern (e.g., a color pattern, a tone pattern, etc.) that they, or other wagering game machines, can use detect and identify based on the light or sound pattern. The wagering game machines 460, 461, 462, 463, 464, and 465, for example, can communicate with each other using the light or sound patterns. The light or sound patterns can include information about content that any of the wagering game machines 460, 461, 462, 463, 464, and 465 has presented, is presenting or will present.

Further, in some embodiments, the system 400 communicates with a rules store to determine whether content presented via any one of the wagering game machines 460, 461, 462, 463, 464, and 465 would conflict with presentation rules for the gaming environment, a wagering game manufacturer, a casino, etc. If, for example, the system 400 determines to present a first color to contrast with a second color, as described in various examples previously, the system 400 can determine whether a casino color code would prohibit the use of certain highly contrasting colors, brightness levels, sound levels, etc., for certain situations (e.g., at certain times of day, when a certain density of patrons are within the environment, etc.).

### EXAMPLE OPERATING ENVIRONMENTS

This section describes example operating environments, systems, networks, etc. and presents structural aspects of some embodiments.

### Wagering Game System Architecture

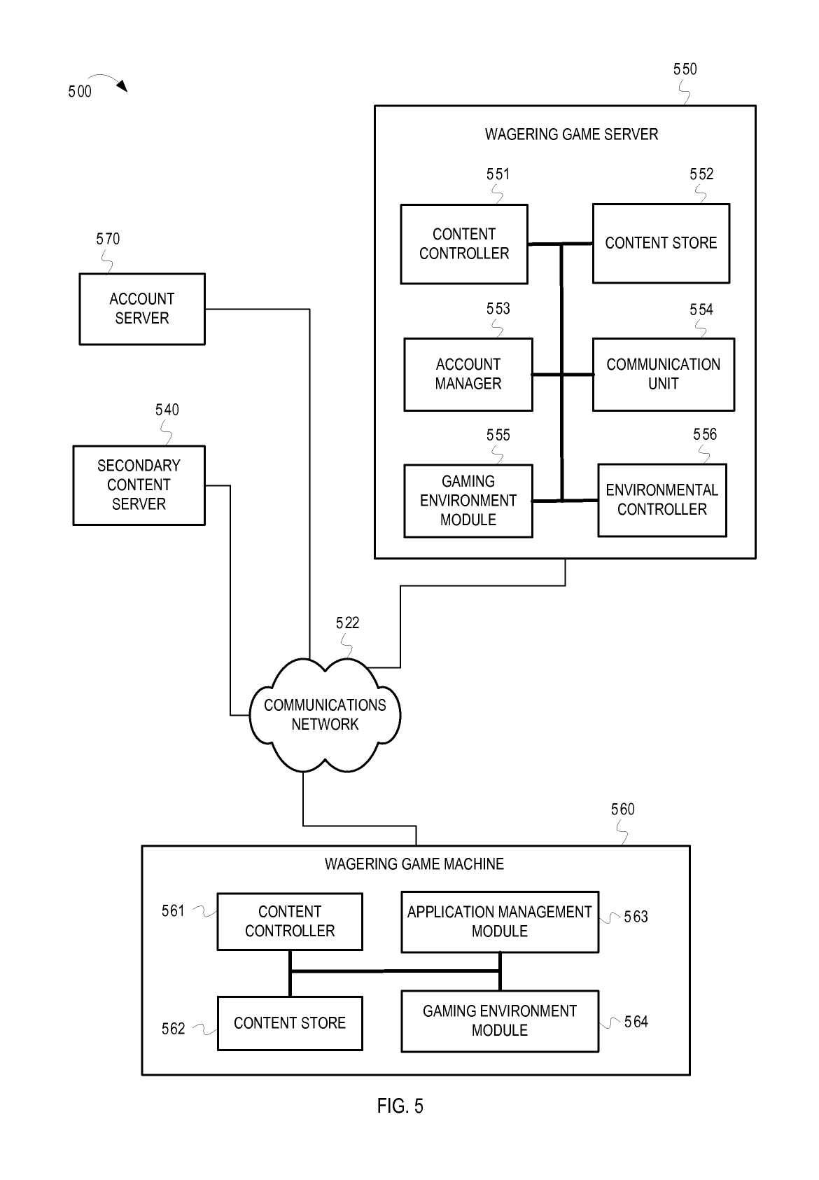

FIG. 5 is a conceptual diagram that illustrates an example of a wagering game system architecture 500, according to some embodiments. The wagering game system architecture 500 can include an account server 570 configured to control user related accounts accessible via wagering game networks. The account server 570 can store wagering game player account information, such as account settings (e.g., settings related to group games, settings related to social contacts, etc.), preferences (e.g., player preferences regarding game content, player preferences regarding award types, preferences related to virtual assets, etc.), player profile data (e.g., name, avatar, screen name, etc.), and other information for a player's account (e.g., financial information, account identification numbers, virtual assets, social contact information, etc.). The account server 570 can contain lists of social contacts referenced by a player account. The account server 570 can also provide auditing capabilities, according to regulatory rules. The account server 570 can also track performance of players, machines, and servers.

The wagering game system architecture 500 can also include a wagering game server 550 configured to control wagering game content, provide random numbers, and communicate wagering game information, account information, and other information to and from a wagering game machine 560. The wagering game server 550 can include a content controller 551 configured to manage and control content for presentation on the wagering game machine 560. For example, the content controller 551 can generate game results (e.g., win/loss values), including win amounts, for games played on the wagering game machine 560. The content controller 551 can communicate the game results to the wagering game machine 560. The content controller 551 can also generate random numbers and provide them to the wagering game machine 560 so that the wagering game machine 560 can generate game results. In some embodiments, the content controller 551 is further configured to provide content, and control information, for secondary games and other secondary content available on a wagering game network (e.g., secondary wagering game content, promotions content, advertising content, player tracking content, web content, etc.). The content controller 551 can provide “secondary” content, or content for “secondary” games presented on the wagering game machine 560. “Secondary” in some embodiments can refer to an application's importance or priority of the data. In some embodiments, “secondary” can refer to a distinction, or separation, from a primary application (e.g., separate application files, separate content, separate states, separate functions, separate processes, separate programming sources, separate processor threads, separate data, separate control, separate domains, etc.). Nevertheless, in some embodiments, secondary content and control can be passed between applications (e.g., via application protocol interfaces), thus becoming, or falling under the control of, primary content or primary applications, and vice versa. In some embodiments, the secondary content can be in one or more different formats, such as Adobe® Flash®, Microsoft® Silverlight™, Adobe® Air™, hyper-text markup language, etc. In some embodiments, the content controller 551 can provide and control content for community games, including networked games, social games, competitive games, or any other game that multiple players can participate in at the same time. In some embodiments, the content controller 551 can control and present an online website that hosts wagering games. The content controller 551 can also be configured to present multiple wagering game applications on the wagering game machine 560 via a wagering game website, or other gaming-type venue accessible via the Internet. The content controller 551 can host an online wagering website and/or a social networking website. The content controller 551 can include other devices, servers, mechanisms, etc., that provide functionality (e.g., controls, web pages, applications, etc.) that web users can use to connect to a social networking application and/or website and utilize social networking and website features (e.g., communications mechanisms, applications, etc.). In some embodiments, the content controller 551 can also host social networking accounts, provide social networking content, control social networking communications, store associated social contacts, etc. The content controller 551 can also provide chat functionality for a social networking website, a chat application, or any other social networking communications mechanism. In some embodiments, the content controller 551 can utilize player data to determine marketing promotions that may be of interest to a player account. The content controller 551 can also analyze player data and generate analytics for players, group players into demographics, integrate with third party marketing services and devices, etc. The content controller 551 can also provide player data to third parties that can use the player data for marketing. In some embodiments, the content controller 551 can provide one or more social networking communication mechanisms that publish (e.g., post, broadcast, etc.) a message to a mass (e.g., to multiple people, users, social contacts, accounts, etc.). The social networking communication mechanism can publish the message to the mass simultaneously. Examples of the published message may include, but not be limited to, a blog post, a mass message post, a news feed post, a profile status update, a mass chat feed, a mass text message broadcast, a video blog, a forum post, etc. Multiple users and/or accounts can access the published message and/or receive automated notifications of the published message. The content controller 551 is further configured to provide and control content for community games, including networked games, social games, competitive games, or any other game that multiple players can participate in at the same time and/or that multiple participants are eligible to participate in when a given playing round, or other event, occurs for the community game.

The wagering game server 550 can also include a content store 552 configured to contain content to present on the wagering game machine 560. The wagering game server 550 can also include an account manager 553 configured to control information related to player accounts. For example, the account manager 553 can communicate wager amounts, game results amounts (e.g., win amounts), bonus game amounts, etc., to the account server 570. The wagering game server 550 can also include a communication unit 554 configured to communicate information to the wagering game machine 560 and to communicate with other systems, devices and networks. The wagering game server 550 can also include a gaming environment module 555 configured to detect environmental input and adapt content based on the environmental input.

The wagering game server 550 can also include a gaming environment module 556 configured to present environmental light and sound effects in a casino environment. The gaming environment module 556 is further configured to provide content data, user data, and control information regarding gaming effects within a casino environment. For example, the gaming environment module 556 can coordinate a synchronized presentation of lighting and sound effects across a bank of wagering game machines and/or other lighting and sound producing devices within one or more areas of a casino. The gaming environment module 556 can also be configured to detect gaming events, such as events generated by the wagering game server 550 and/or the wagering game machine 560. The gaming environment module 556 can generate data for a synchronized light/sound show based on the gaming events. The gaming environment module 556 can control environmental light presentation devices within a casino. The gaming environment module 556 can provide emotive lighting presentation data, including light presentation commands on emotive lighting devices on or near wagering game machines, as well as other devices within the casino such as spotlights, overhead emotive lighting, projectors, etc. The gaming environment module 556 can be configured to determine multi-media, casino-content, including casino-wide special effects that include sound effects and light effects. The multi-media casino content can be presentable across a plurality of casino content presentation devices (“presentation devices”) in a casino. The multi-media, casino-content effect can be related to a wagering game presentation or event. The wagering game presentation or event can be tied to the functionality, activity, or purpose of a wagering game. For instance, wagering game presentations can be related to attracting wagering game players to groups of wagering game machines, presenting game related outcomes across multiple wagering game machines, expressing group gaming activity across multiple wagering game machines, focusing attention on a particular person or machine in response to a gaming event, etc. The presentation devices present sound and light effects that accompany a gaming event (e.g., a jackpot celebratory effect that focuses on a wagering game machine, a lightning strike that introduces a community gaming event, and a musical chair game that reveals a community wagering game winner). The gaming environment module 556 can also be configured to determine timing control data for the multi-media effect. In some embodiments, timing control data can be stored on the wagering game server 550, or be accessible to the gaming environment module 556 via another device (e.g., a lighting controller associated with a bank of wagering game machines), to use to send lighting commands in sequential order to network addresses of presentation device on a casino network. The gaming environment module 556 can determine channels assigned with casino-content presentation devices, such as the wagering game machine 560. In some embodiments, the presentation devices can have addresses assigned to a channel. For example, the wagering game machine 560 could be on one channel, peripheral devices could be on another channel, network light presentation devices can be on other channels, etc. In some embodiments, the gaming environment module 556 can be a DMX controller connected in parallel to an emotive lighting controller on, or associated with, the wagering game machine 560. The DMX controller can also be connected in parallel to a plurality of other presentation devices (e.g., other wagering game machines, lighting presentation devices, etc.) within a casino, and can simultaneously provide DMX lighting commands to the wagering game machine 560 and to the other presentation devices. DMX can change light intensity, or other light characteristics, over time. Some embodiments of DMX controllers can update commands very quickly (e.g., 30-47 times a second) across multiple channels (e.g., 512 channels). A DMX controller can put different commands in every channel (e.g., one channel can have show “X,” one channel can have show “Y,” etc.). The DMX can also have a frame number within a show. Some devices can take up more than one channel (e.g., an emotive light might have three colors and may take up a channel for each color, a spotlight might have seven channels, etc.). Each device can receive 512 bytes of data from the DMX controller at any given time interval (e.g., frame). The 512 bytes of data can be divided in different ways. For example, 6 bytes may address light effect behavior, 6 bytes may include show numbers, 6 bytes may include frame numbers, 1 byte may include priority values, and so on for various light effect characteristics (e.g., intensity, color, pan, tilt, etc.). The presentation device that receives the DMX command data is programmed to interpret the lighting data in the channel. In some embodiments, the presentation devices can be DMX compliant including having a DMX input port to accept DMX commands. In some embodiments, presentation devices can convert the DMX commands to proprietary commands. In addition to the DMX protocol, other types of dedicated lighting protocols can include AMX 192, CMX, SMX, PMX, protocols included in the EIA-485 standard, etc.

The wagering game system architecture 500 can also include the wagering game machine 560 configured to present wagering games and receive and transmit information to control wagering game peripherals. The wagering game machine 560 can include a content controller 561 configured to manage and control content and presentation of content on the wagering game machine 560. The content controller 561 is further configured to work in conjunction with an application management module 563 to perform instructions received by, and or generate instructions on behalf of, an application management module 563, such as, to manipulate and control windows, or other user interfaces, presented on the wagering game machine 560. The content controller 561 is further configured to control and communicate account information (e.g., financial transactions, player tracking information, etc.). The content controller 561 is further configured to present secondary content applications (e.g., client player instances). The content controller 561 can receive event data from, and provide event data to, the application management module 563. The content controller 561 is further configured to manage and control the presentation of secondary content on the wagering game machine 560, which secondary content is specific to one or more secondary content clients.

The wagering game machine 560 can also include a content store 562 configured to contain content to present on the wagering game machine 560. The wagering game machine 560 can also include the application management module 563 configured to manage multiple instances of gaming applications. For example, the application management module 563 can be configured to launch, load, unload and control applications and instances of applications. The application management module 563 can launch different software players (e.g., a Microsoft® Silverlight™ player, an Adobe® Flash® player, etc.) and manage, coordinate, and prioritize what the software players do. The application management module 563 can also coordinate instances of server applications in addition to local copies of applications. The application management module 563 can control window locations on a wagering game screen or display for the multiple gaming applications. In some embodiments, the application management module 563 can manage window locations on multiple displays including displays on devices associated with and/or external to the wagering game machine 560 (e.g., a top display and a bottom display on the wagering game machine 560, a peripheral device connected to the wagering game machine 560, a mobile device connected to the wagering game machine 560, etc.). The application management module 563 can manage priority or precedence of client applications that compete for the same display area. For instance, the application management module 563 can determine each client application's precedence. The precedence may be static (i.e. set only when the client application first launches or connects) or dynamic. The applications may provide precedence values to the application management module 563, which the application management module 563 can use to establish order and priority. The precedence, or priority, values can be related to tilt events, administrative events, primary game events (e.g., hierarchical, levels, etc.), secondary game events, local bonus game events, advertising events, etc. As each client application runs, it can also inform the application management module 563 of its current presentation state. The applications may provide presentation state values to the application management module 563, which the application management module 563 can use to evaluate and assess priority. Examples of presentation states may include celebration states (e.g., indicates that client application is currently running a win celebration), playing states (e.g., indicates that the client application is currently playing), game starting states (e.g., indicates that the client application is showing an invitation or indication that a game is about to start), status update states (e.g., indicates that the client application is not ‘playing’ but has a change of status that should be annunciated, such as a change in progressive meter values or a change in a bonus game multiplier), idle states (e.g., indicates that the client application is idle), etc. In some embodiments, the application management module 563 can be pre-configurable. The system can provide controls and interfaces for operators to control screen layouts and other presentation features for the configuring of the application management module 563. The application management module 563 can communicate with, and/or be a communication mechanism for, a base game stored on a wagering game machine. For example, the application management module 563 can communicate events from the base game such as the base game state, pay line status, bet amount status, etc. The application management module 563 can also provide events that assist and/or restrict the base game, such as providing bet amounts from secondary gaming applications, inhibiting play based on gaming event priority, etc. The application management module 563 can also communicate some (or all) financial information between the base game and other applications including amounts wagered, amounts won, base game outcomes, etc. The application management module 563 can also communicate pay table information such as possible outcomes, bonus frequency, etc.

In some embodiments, the application management module 563 can control different types of applications. For example, the application management module 563 can perform rendering operations for presenting applications of varying platforms, formats, environments, programming languages, etc. For example, the application management module 563 can be written in one programming language format (e.g., Javascript, Java, C++, etc.) but can manage, and communicate data from applications that are written in other programming languages or that communicate in different data formats (e.g., Adobe® Flash®, Microsoft® Silverlight™, Adobe® Air™, hyper-text markup language, etc.). The application management module 563 can include a portable virtual machine capable of generating and executing code for the varying platforms, formats, environments, programming languages, etc. The application management module 563 can enable many-to-many messaging distribution and can enable the multiple applications to communicate with each other in a cross-manufacturer environment at the client application level. For example, multiple gaming applications on a wagering game machine may need to coordinate many different types of gaming and casino services events (e.g., financial or account access to run spins on the base game and/or run side bets, transacting drink orders, tracking player history and player loyalty points, etc.).

The wagering game machine 560 can also include a gaming environment module 564 configured to detect environmental input and adapt content based on the environmental input.

Each component shown in the wagering game system architecture 500 is shown as a separate and distinct element connected via a communications network 522. However, some functions performed by one component could be performed by other components. For example, the wagering game server 550 can also be configured to perform functions of the application management module 563 and other network elements and/or system devices. Furthermore, the components shown may all be contained in one device, but some, or all, may be included in, or performed by, multiple devices, as in the configurations shown in FIG. 5 or other configurations not shown. For example, the account manager 553 and the communication unit 554 can be included in the wagering game machine 560 instead of, or in addition to, being a part of the wagering game server 550. Further, in some embodiments, the wagering game machine 560 can determine wagering game outcomes, generate random numbers, etc. instead of, or in addition to, the wagering game server 550.

The wagering game machines described herein (e.g., wagering game machine 560) can take any suitable form, such as floor standing models, handheld mobile units, bar-top models, workstation-type console models, surface computing machines, etc. Further, wagering game machines can be primarily dedicated for use in conducting wagering games, or can include non-dedicated devices, such as mobile phones, personal digital assistants, personal computers, etc.

In some embodiments, wagering game machines and wagering game servers work together such that wagering game machines can be operated as thin, thick, or intermediate clients. For example, one or more elements of game play may be controlled by the wagering game machines (client) or the wagering game servers (server). Game play elements can include executable game code, lookup tables, configuration files, game outcome, audio or visual representations of the game, game assets or the like. In a thin-client example, the wagering game server can perform functions such as determining game outcome or managing assets, while the wagering game machines can present a graphical representation of such outcome or asset modification to the user (e.g., player). In a thick-client example, the wagering game machines can determine game outcomes and communicate the outcomes to the wagering game server for recording or managing a player's account.

In some embodiments, either the wagering game machines (client) or the wagering game server(s) can provide functionality that is not directly related to game play. For example, account transactions and account rules may be managed centrally (e.g., by the wagering game server(s)) or locally (e.g., by the wagering game machines). Other functionality not directly related to game play may include power management, presentation of advertising, software or firmware updates, system quality or security checks, etc.

Furthermore, the wagering game system architecture 500 can be implemented as software, hardware, any combination thereof, or other forms of embodiments not listed. For example, any of the network components (e.g., the wagering game machines, servers, etc.) can include hardware and machine-readable storage media including instructions for performing the operations described herein.

### Wagering Game Machine Architecture

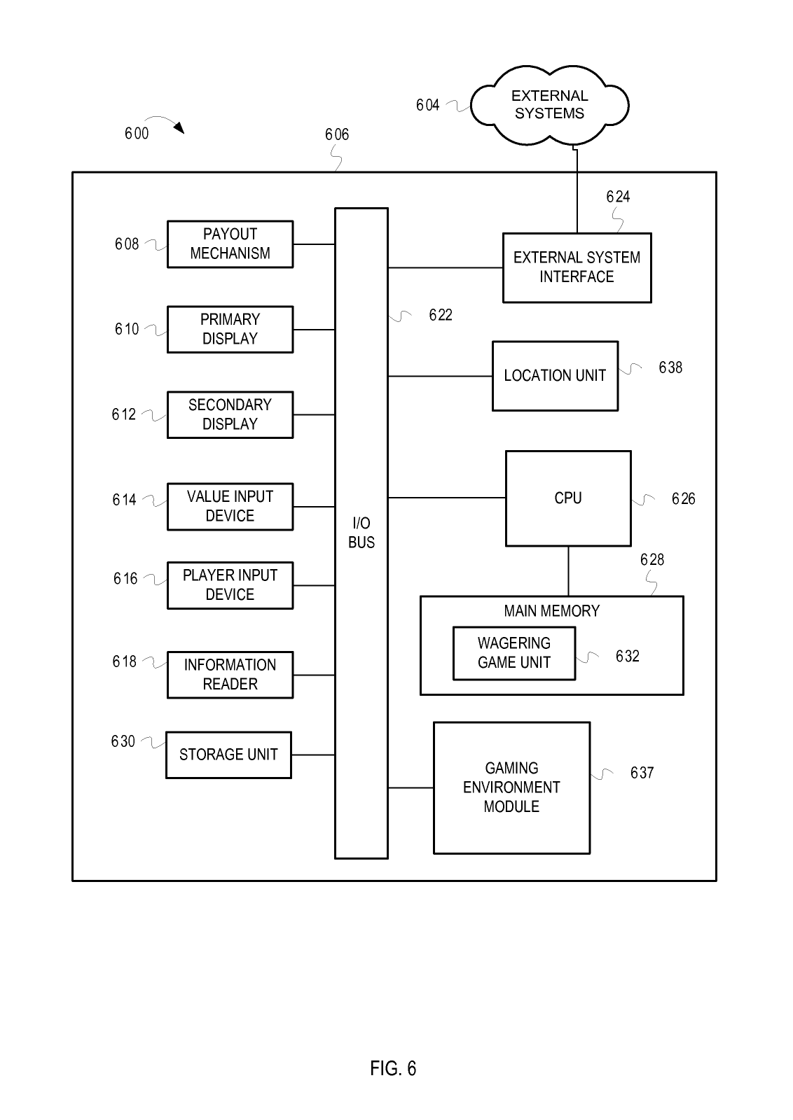

FIG. 6 is a conceptual diagram that illustrates an example of a wagering game machine architecture 600, according to some embodiments. In FIG. 6, the wagering game machine architecture 600 includes a wagering game machine 606, which includes a central processing unit (CPU) 626 connected to main memory 628. The CPU 626 can include any suitable processor, such as an Intel® Pentium processor, Intel® Core 2 Duo processor, AMD Opteron™ processor, or UltraSPARC processor. The main memory 628 includes a wagering game unit 632. In some embodiments, the wagering game unit 632 can present wagering games, such as video poker, video black jack, video slots, video lottery, reel slots, etc., in whole or part.

The CPU 626 is also connected to an input/output (“I/O”) bus 622, which can include any suitable bus technologies, such as an AGTL+ frontside bus and a PCI backside bus. The I/O bus 622 is connected to a payout mechanism 608, primary display 610, secondary display 612, value input device 614, player input device 616, information reader 618, and storage unit 630. The player input device 616 can include the value input device 614 to the extent the player input device 616 is used to place wagers. The I/O bus 622 is also connected to an external system interface 624, which is connected to external systems 604 (e.g., wagering game networks). The external system interface 624 can include logic for exchanging information over wired and wireless networks (e.g., 802.11g transceiver, Bluetooth transceiver, Ethernet transceiver, etc.)

The I/O bus 622 is also connected to a location unit 638. The location unit 638 can create player information that indicates the wagering game machine's location/movements in a casino. In some embodiments, the location unit 638 includes a global positioning system (GPS) receiver that can determine the wagering game machine's location using GPS satellites. In other embodiments, the location unit 638 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 6, in some embodiments, the location unit 638 is not connected to the I/O bus 622.

In some embodiments, the wagering game machine 606 can include additional peripheral devices and/or more than one of each component shown in FIG. 6. For example, in some embodiments, the wagering game machine 606 can include multiple external system interfaces 624 and/or multiple CPUs 626. In some embodiments, any of the components can be integrated or subdivided.

In some embodiments, the wagering game machine 606 includes a gaming environment module 637. The gaming environment module 637 can process communications, commands, or other information, where the processing can adapt gaming content to a gaming environment.

Furthermore, any component of the wagering game machine 606 can include hardware, firmware, and/or machine-readable storage media including instructions for performing the operations described herein.

### Wagering Game System

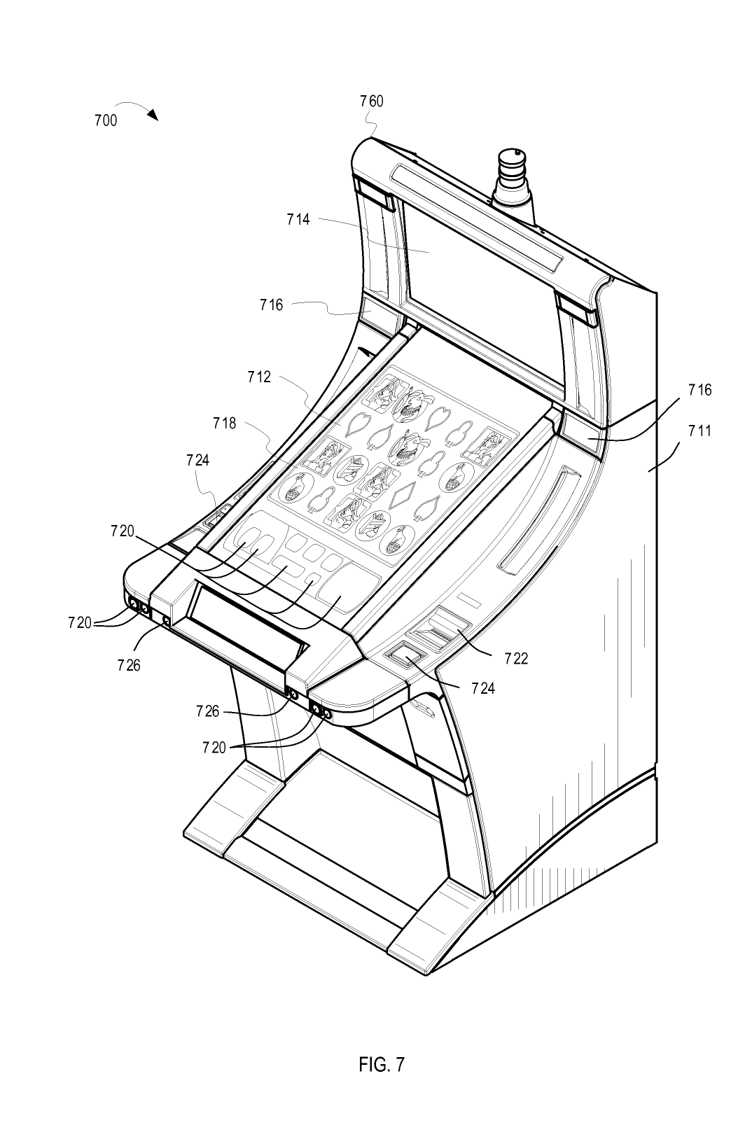

FIG. 7 is a conceptual diagram that illustrates an example of a wagering game system 700, according to some embodiments. In FIG. 7, the wagering game system 700 includes a wagering game machine 760 similar to those used in gaming establishments, such as casinos. The wagering game machine 760 may, in some examples, be referred to as a gaming terminal or an electronic gaming machine. The wagering game machine 760 may have varying structures and methods of operation. For example, the wagering game machine 760 may include electromechanical components configured to play mechanical slots. In another example, the 760 includes electronic components configured to play a video casino game, such as slots, keno, poker, blackjack, roulette, craps, etc. The wagering game machine 760 is depicted as a floor-standing model. However, other examples of wagering game machines include handheld mobile units, bartop models, workstation-type console models, etc. Further, the wagering game machine 760 may be primarily dedicated for use in conducting wagering games, or may include non-dedicated devices, such as mobile phones, personal digital assistants, personal computers, etc. Exemplary types of wagering game machines are disclosed in U.S. Pat. No. 6,517,433 and Patent Application Publication Nos. US2010/0062196 and US2010/0234099, which are incorporated herein by reference in their entireties.

The wagering game machine 760 illustrated in FIG. 7 comprises a cabinet 711 that may house various input devices, output devices, and input/output devices. By way of example, the wagering game machine 760 includes a primary display area 712, a secondary display area 714, and one or more audio speakers 716. The primary display area 712 or the secondary display area 714 may include one or more of a cathode ray tube (CRT), a high resolution liquid crystal display (LCD), a plasma display, a light emitting diode (LED) display, a three-dimensional (3D) display, a video display, or a combination thereof. In some examples, the primary display area 712 or the secondary display area 714 includes mechanical reels to display a wagering game outcome. In some example, the primary display area 712 or the secondary display area 714 present a transmissive video display disposed in front of a mechanical-reel display to portray a video image superimposed upon the mechanical-reel display. In FIG. 7, the wagering game machine 760 is a “slant-top” version in which the primary display 712 is slanted (e.g., at about a thirty-degree angle toward the player of the wagering game machine 760). Another example of wagering game machine 760 is an “upright” version in which the primary display 714 is oriented vertically relative to the player. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the wagering game machine 760. The wagering game machine 760 includes a touch screen(s) 718 mounted over the primary or secondary areas, buttons 720 on a button panel, bill validator 722, information reader/writer(s) 724, and player-accessible port(s) 726 (e.g., audio output jack for headphones, video headset jack, USB port, wireless transmitter/receiver, etc.). It should be understood that numerous other peripheral devices and other elements exist and are readily utilizable in any number of combinations to create various forms of a wagering game machine in accord with the present concepts.

Input devices, such as the touch screen 718, buttons 720, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer readable program code embodied in the medium. The described embodiments may be provided as a computer program product that may include a machine-readable storage medium having stored thereon instructions, which may be used to program a computer system to perform a process according to embodiments(s), whether presently described or not, because every conceivable variation is not enumerated herein. A machine-readable storage medium includes any mechanism that stores information in a form (e.g., software, processing application) readable by a machine (e.g., a computer). For example, machine-readable storage media includes magnetic storage medium (e.g., floppy diskette), read only memory (ROM), random access memory (RAM), magnetic disk storage media, optical storage media (e.g., CD-ROM), magneto-optical storage media, flash memory, erasable programmable memory (e.g., EPROM and EEPROM), or other types of media suitable for storing electronic instructions. In addition, embodiments may be embodied in a machine-readable signal media, such as any media suitable for transmitting software over a network.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments, which are defined only by the appended claims. Each of the embodiments described herein are contemplated as falling within the inventive subject matter, which is set forth in the following claims.

1. A computer-implemented method comprising:
detecting, via one or more sensors associated with a wagering game machine, environmental input from an environment surrounding the wagering game machine;
analyzing, via one or more processors, the environmental input;
determining, via at least one of the one or more processors, a characteristic of the environment based on the analyzing of the environmental input; and
based on the characteristic, determining, via at least one of the one or more processors, content to present via an output device associated with the wagering game machine.

2. The computer-implemented method of claim 1,
wherein the determining the characteristic of the environment comprises detecting a first color of a visual effect presented within a given proximity to the wagering game machine, and
wherein the determining the content to present comprises selecting a visual effect with a second color different from the first color.

3. The computer-implemented method of claim 1,
wherein the determining the characteristic of the environment comprises detecting a first sound characteristic of an audio effect presented within a given proximity to the wagering game machine, and
wherein the determining the content to present comprises selecting an audio effect with a second sound characteristic different from the first sound characteristic.

4. The computer-implemented method of claim 1, wherein the detecting the environmental input comprises detecting presentation of additional content of an additional wagering game machine within a given distance from the wagering game machine.

5. The computer-implemented method of claim 1, wherein the detecting the environmental input comprises detecting a perspective of a user within the environment and presenting the content based on the perspective of the user.

6. The computer-implemented method of claim 1 further comprising:
detecting a user-preference for a characteristic of the content, wherein the characteristic of the content is different from the characteristic of the environment; and
selecting the content based on detecting of the user-preference for the characteristic of the content.

7. The computer-implemented method of claim 1, wherein the determining the characteristic of the environment comprises determining that the environment has a first property, and wherein the determining the content to present comprises selecting a second property of the content that contrasts with the first property.

8. The computer-implemented method of claim 1, wherein the determining the characteristic of the environment comprises determining the environment has a first property, and wherein the determining the content to present comprises selecting a second property of the content that conforms with the first property.

9. The computer-implemented method of claim 1, wherein the content is apart from wagering game content for a wagering game presented during a wagering game session conducted via the wagering game machine.

10. The computer-implemented method of claim 1 further comprising altering one or more of color content, sound content, attract content, a game theme, and functionality of a wagering game based on the characteristic.

11. The computer-implemented method of claim 1 further comprising:
coordinating presentation of the content with one or more additional content presentations within a casino.

12. The computer-implemented method of claim 1 further comprising:
constructing a map of a casino floor, wherein the map indicates a location of the wagering game machine and additional wagering game machines on the casino floor;
indicating, via the map, first information about the content to present via the output device; and
indicating, via the map, second information about additional content to concurrently present via additional output devices associated with the additional wagering game machines.

13. One or more machine-readable storage devices having instructions stored thereon, which when executed by a set of one or more processors causes the set of one or more processors to perform operations comprising:
detecting environmental input of an environment surrounding a wagering game machine;
analyzing the environmental input;
determining a characteristic of the environment based on the analyzing of the environmental input; and
based on the characteristic, adapting presentation of content via an output device associated with the wagering game machine.

14. The one or more machine-readable storage devices of claim 13, wherein the operation for detecting the environmental input of the environment comprises recording additional content presented within the environment, and wherein the operation for analyzing the environmental input comprises analyzing the recording of the additional content.

15. The one or more machine-readable storage devices of claim 13, wherein the operation for determining the characteristic of the environment based on the analyzing of the environmental input includes operations further comprising:
detecting an identity of an object within the environment; and
determining a description of the characteristic based on the identity of the object.

16. The one or more machine-readable storage devices of claim 13, wherein the operation for adapting presentation of the content comprises:
querying a data store with the description of the characteristic;
detecting, from the querying, that the data store includes the content; and
selecting the content from the data store.

17. The one or more machine-readable storage devices of claim 13, wherein the operation for detecting the environmental input comprises an operation for detecting a presentation pattern of additional content presented from an additional device within the environment; and wherein said operation for determining content to present includes on operation comprising selecting content that conforms to the presentation pattern.

18. A system comprising:
at least one processor; and
at least one memory device configured to store instructions which, when executed by the at least one processor, cause the system to,
detect environmental input of an environment surrounding a wagering game machine,
analyze the environmental input,
determine a characteristic of the environment based on analysis of the environmental input, and
based on the characteristic, determine content to present via an output device associated with the wagering game machine.

19. The system of claim 18, wherein the instruction to detect the environmental input of the environment is configured to record additional content presented within the environment, and wherein the instruction to analyze the environmental input is configured to analyze the recording of the additional content.

20. The system of claim 18, wherein instruction to determine the characteristic of the environment based on the analysis of the environmental input is configured to detect an identity of an object within the environment and determine a description of the characteristic based on the identity of the object.

21. The system of claim 18, wherein the instruction to determine the content to present comprises one or more instructions which, when executed by the at least one processor, causes the system to
query a data store with the description of the characteristic,
detect, from the querying, that the data store includes the content, and
select the content from the data store.

22. The system of claim 18, wherein the instruction to detect the environmental input is configured to detect a presentation pattern of additional content presented from an additional device within the environment; and wherein said instruction to determine content to present is configured to select content that conforms to the presentation pattern.

23. An apparatus comprising:
at least one input device configured to receive an indication of a wager to play a wagering game;
at least one display device configured to display the wagering game;
at least one processor; and
at least one memory device configured to store instructions which, when executed by the at least one processor, cause the apparatus to
detect environmental input of an environment for a wagering game venue,
analyze the environmental input,
determine a first characteristic of first content presented within the environment based on analysis of the environmental input, and
based on the first characteristic, determine a second characteristic to present via second content, wherein the second content is configured for presentation via an output device within the wagering game venue, and wherein the second characteristic contrasts with the first characteristic.

24. The apparatus of claim 23, wherein the first characteristic is one or more of a first color and a first sound and wherein the second characteristic is one or more of a second color different from the first color and a second sound different from the first sound.

25. An apparatus comprising:
means for detecting environmental input from an environment surrounding a wagering game machine;
means for analyzing the environmental input;
means for determining a first characteristic of first content presented within the environment based on analysis of the environmental input, and
based on the first characteristic, determining a second characteristic to present via second content, wherein the second content is configured for presentation via an output device associated with the wagering game machine, and wherein the second characteristic conforms to the first characteristic

26. The apparatus of claim 25, wherein the first characteristic is a presentation pattern of the first content and wherein the second content includes a timing pattern for presentation of the second content that coordinates with the presentation pattern.
